(19) United States
(12) Patent Application Publication
(10) Pub. No.: US 2019/0085541 A1
(43) Pub. Date: Mar. 21, 2019

(54) PEDAL CONTROLLED FAUCET RETROFIT KIT

(71) Applicants: Kirk Jason Anderson, Agoura Hills, CA (US); Avi Eshed, Agoura Hills, CA (US)

(72) Inventors: Kirk Jason Anderson, Agoura Hills, CA (US); Avi Eshed, Agoura Hills, CA (US)

(21) Appl. No.: 16/137,050

(22) Filed: Sep. 20, 2018

Related U.S. Application Data
(60) Provisional application No. 62/560,842, filed on Sep. 20, 2017.

(51) Int. Cl. E03C 1/05; E03C 1/02; F16K 31/06

(52) U.S. Cl. CPC E03C 1/055; F16K 31/0675; E03C 1/052; E03C 1/025

(57) ABSTRACT

The present disclosure provides a system and method for retrofitting existing standard faucets to conserve water as well as decrease the likelihood of spreading viruses and bacteria via contact with the faucet itself. The system includes a foot pedal that the user can activate to control the flow of water. The foot pedal communicates with an electric valve system that opens and closes on demand. The foot pedal and electric valve system can be quickly and easily installed into a standard faucet system, thereby converting the standard faucet system into a hands free faucet system.

### BACKGROUND

Faucets are typically turned on and off using a hand actuated lever or knob. The manual knobs and levers of these standard faucet systems can act as a vehicle for transmission of contaminants from one user to another. In addition, these standard faucet systems often result in the wasting of water, as the water is routinely running longer than necessary as the faucet must be manually activated both before and after use. Although some modern sensor activated automatic faucets address some of these drawbacks, there remains a need for systems that can be easily used to retrofit existing faucets to address their drawbacks.

### SUMMARY

The present disclosure provides a system and method for retrofitting existing standard faucets to conserve water as well as decrease the likelihood of spreading viruses and bacteria via contact with the faucet itself. In the depicted embodiment, the system includes a foot pedal that the user can activate to control the flow of water. In the depicted embodiment, the foot pedal communicates with an electric valve system that opens and closes on demand. In the depicted embodiment, the foot pedal and electric valve system can be quickly and easily installed into a standard faucet system, thereby converting the standard faucet system into a hands free faucet system.

### BRIEF DESCRIPTION OF THE FIGURES

FIG. 1 is an illustration of a step in the installation of the apparatus in accordance with an embodiment of the present disclosure;

FIG. 2 is an illustration of a step in the installation of the apparatus in accordance with an embodiment of the present disclosure;

FIG. 3 is an illustration of a step in the installation of the apparatus in accordance with an embodiment of the present disclosure;

FIG. 4 is an illustration of a step in the installation of the apparatus in accordance with an embodiment of the present disclosure;

FIG. 5 is an illustration of a step in the installation of the apparatus in accordance with an embodiment of the present disclosure;

FIG. 6 is an illustration of a step in the installation of the apparatus in accordance with an embodiment of the present disclosure;

FIG. 7 is an illustration of a step in the installation of the apparatus in accordance with an embodiment of the present disclosure; and

FIGS. 8-15 illustrate various components of hardware according to the system of the present disclosure.

### DETAILED DESCRIPTION

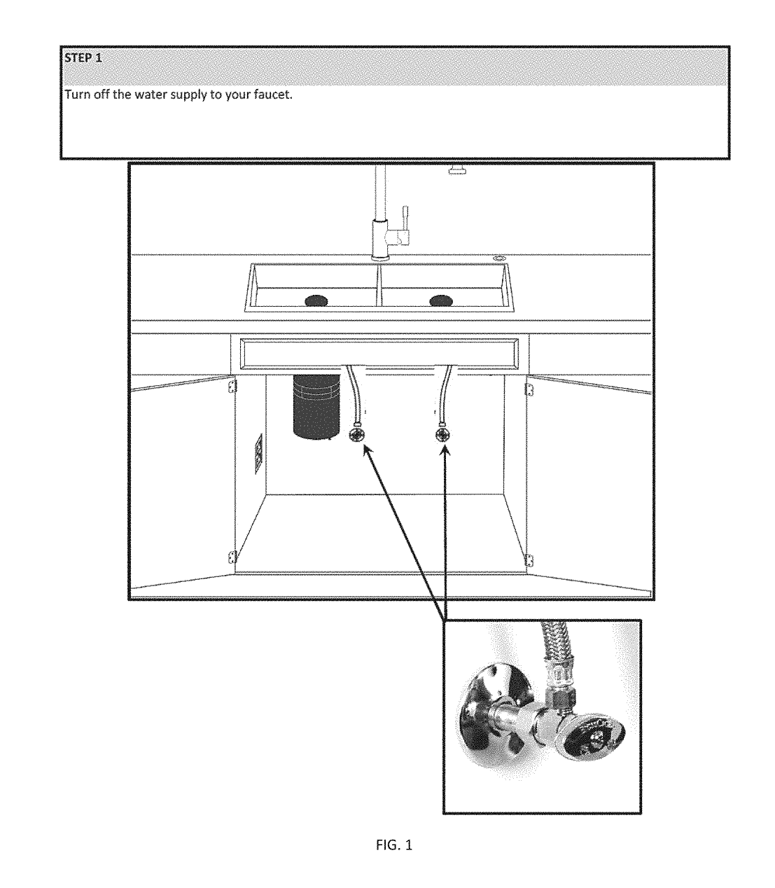

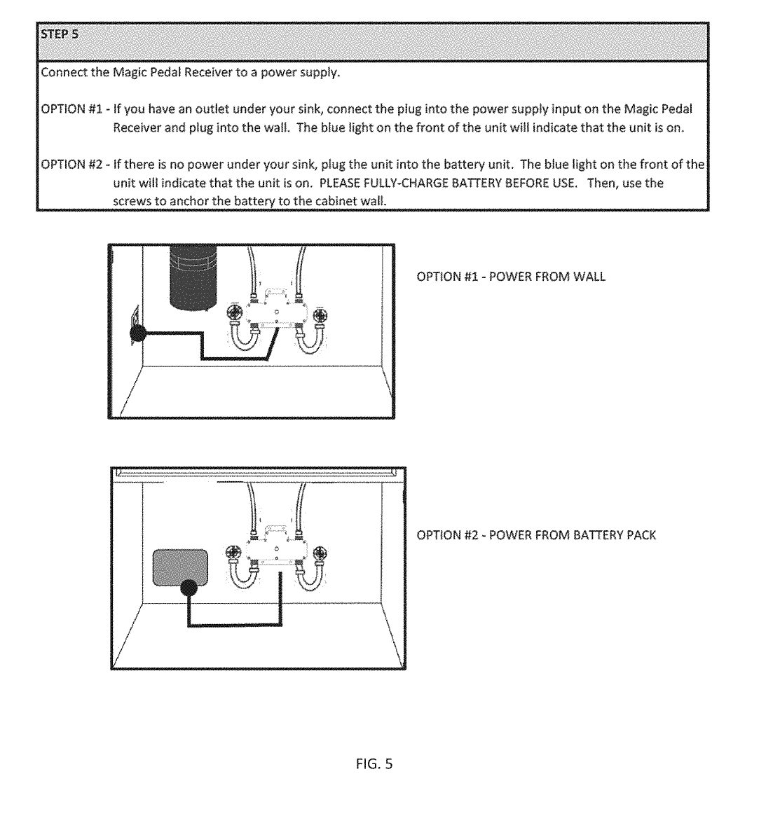

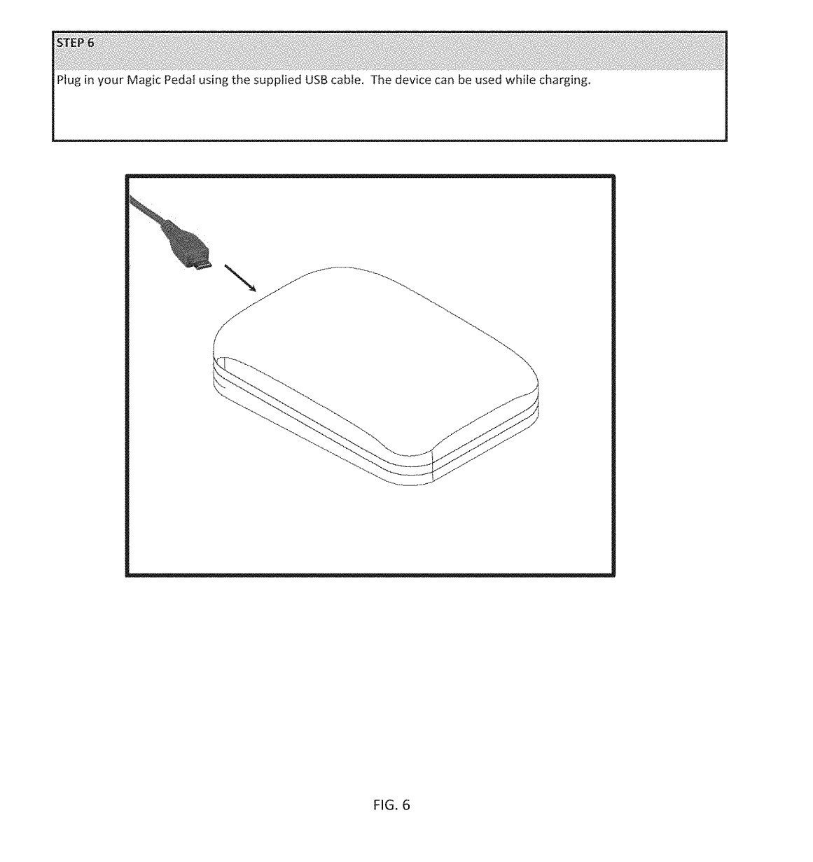

An embodiment of the system and method of retrofitting a standard faucet according to principles of the present disclosure is described with reference to FIGS. 1-7. It should be appreciated that many alternative methods of retrofitting a faucet according to the principles of the present disclosure are also possible.

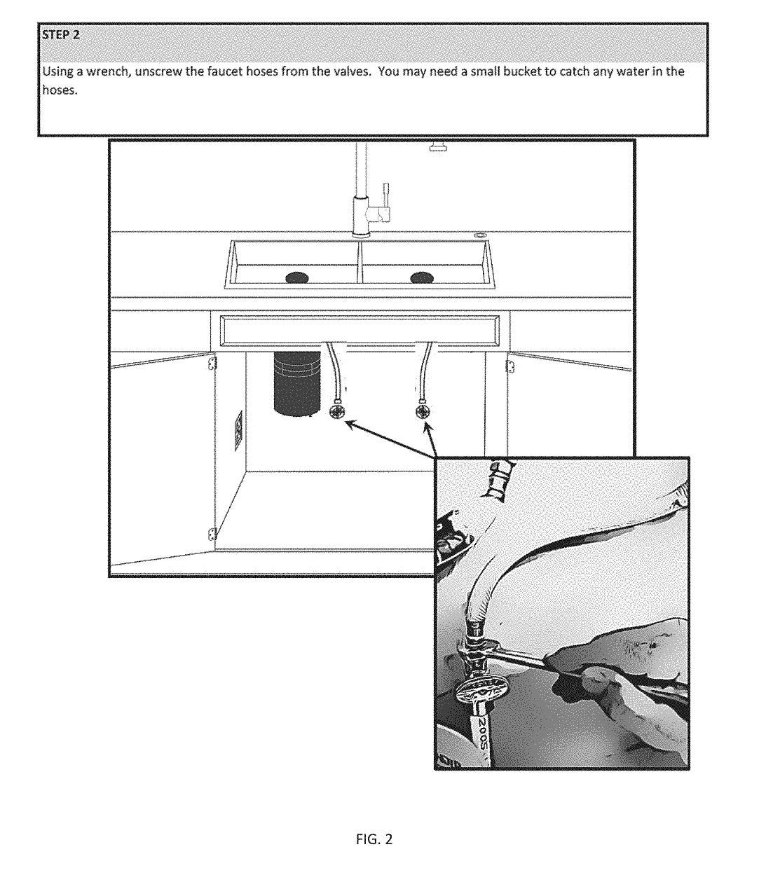

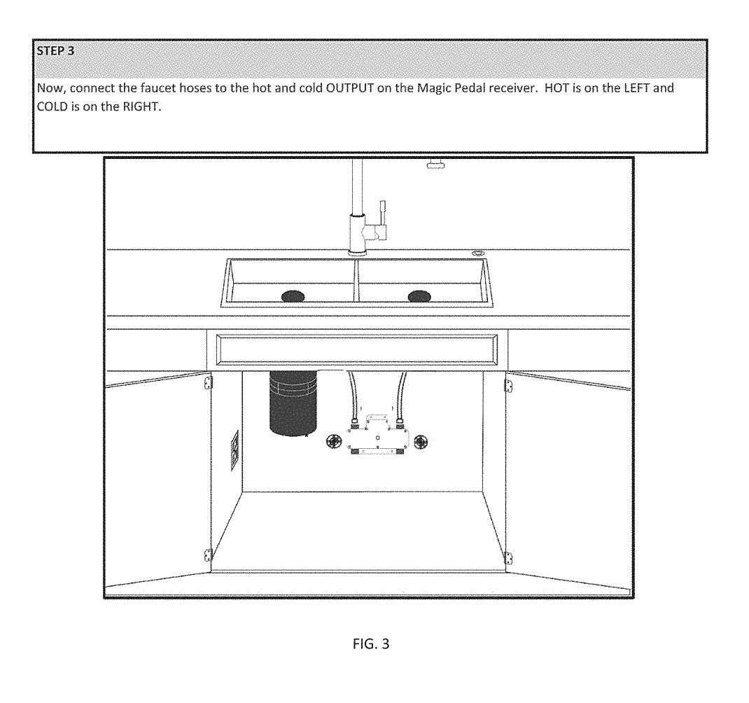

In the depicted embodiment, the first step is to turn off the water supply by turning the existing manual valves connected to the hot and cold water lines clockwise as is illustrated in FIG. 1. Once the water is turned off, the next step is to disconnect the faucet hoses from the existing manual water supply valves. This can be accomplished with a wrench as is illustrated in FIG. 2. After the faucet hoses are disconnected from the manual valves, the next step is to connect the faucet hoses to the hot and cold outputs on the valve system of the present disclosure, which is also referred to herein as the Magic Pedal Receiver. This step is illustrated in FIG. 3.

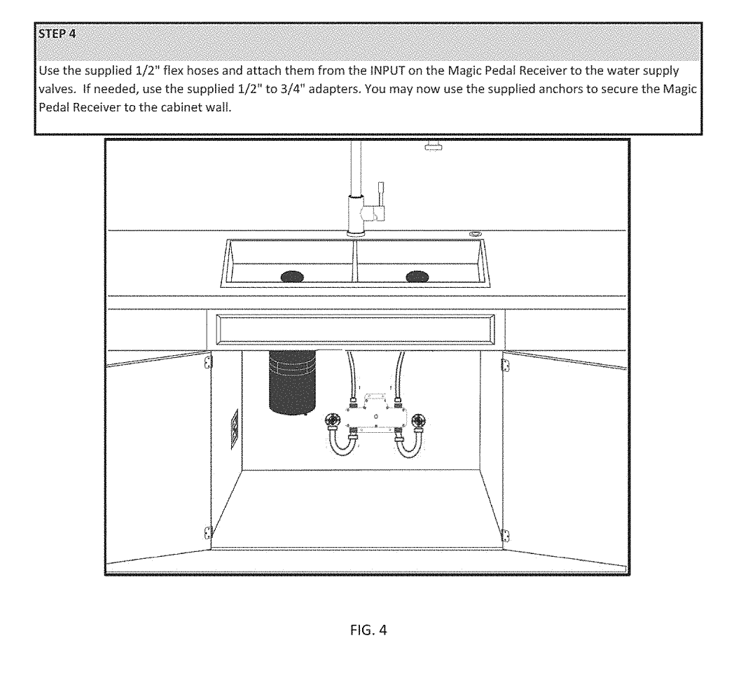

The next step is to connect flex hoses between the input of the valve system of the present disclosure (aka the Magic Pedal Receiver) to the hot and cold water sources. In particular, the flex hose is connected to the hot manual valve to the input of the valve system for hot water and the flex hose is connected to the cold manual valve to the input of the valve system for cold water. This step can be done with a wrench as well. This step is illustrated in FIG. 4. It should be appreciated that the steps of the method of the present disclosure can be accomplished in a different order than shown. For example, step 4 of FIG. 4 could be done before or after step 3 of FIG. 3. Many other variations of the method are also possible. For example, a rigid hose rather than a flex hose can be used.

In the depicted embodiment, the valve system operates on electrical power. The valve system of the present disclosure can be connected to an electricity source by plugging the valve system into a standard wall outlet and/or by connecting the valve system into another power source such as a battery. In the depicted embodiment, the battery power source is shown as a separate unit that can be mounted via a mounting system to the cabinet below a sink. It should be appreciated that many alternative configurations are also possible. For example, the battery unit could also be directly connected to the valve system or could be an integrated part of the valve system itself. Alternatively, the battery can be remote from the valve system (e.g., a RV house battery) and wires can deliver the power to the valve system.

In the depicted embodiment, the pedal is also electrically powered. The pedal can be powered by internal batteries that can be recharged with a micro USB connection or some other mechanism. For example, the batteries could be removed and replaced (e.g., standard AA batteries), built in and rechargeable, or the pedal could be powered via an electrical wire as opposed to a battery.

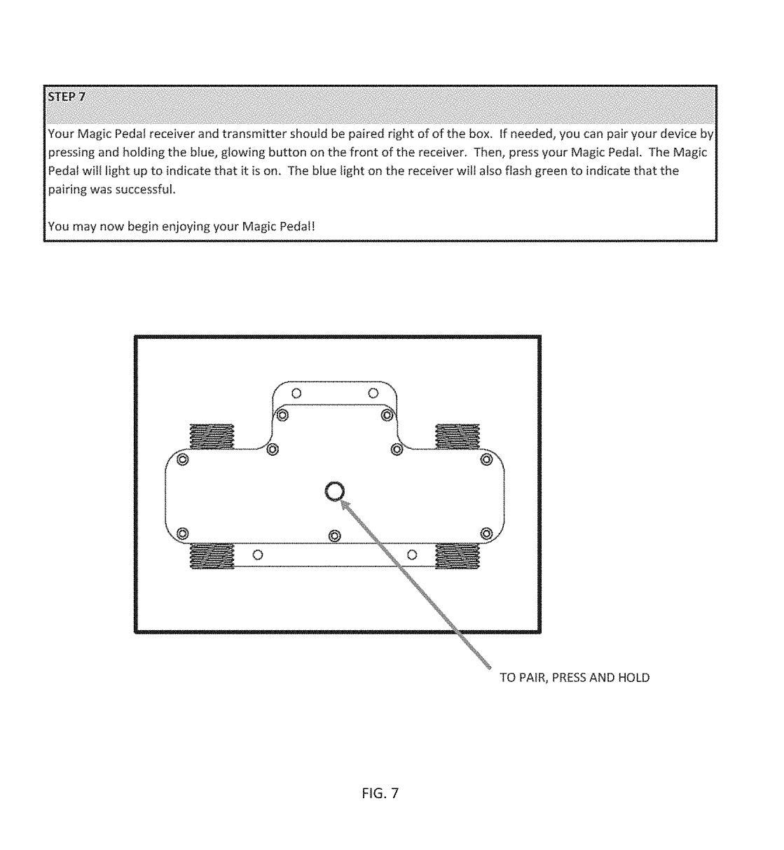

In the depicted embodiment, the pedal and the valve system can be paired so that they can communicate with each other. The pairing can be done by pressing and holding a button on the valve system as shown in FIG. 7. As discussed above, the method of the present disclosure can include more or less steps, and the steps do not necessarily need to be in the order illustrated and described herein. It should be appreciated that many alternatives are also possible. For example, the pairing of the pedal and the valve system can be done via matching DIP switches on each of the components.

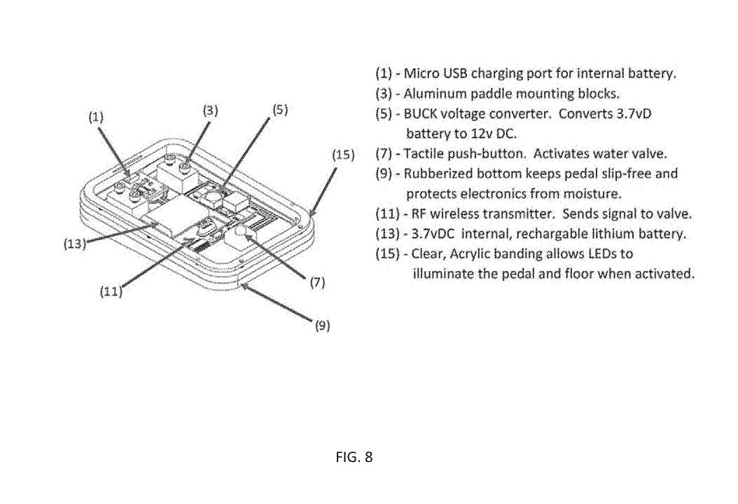

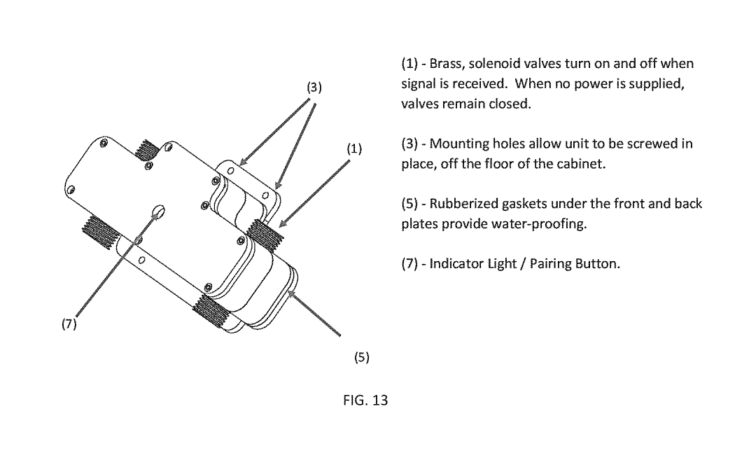

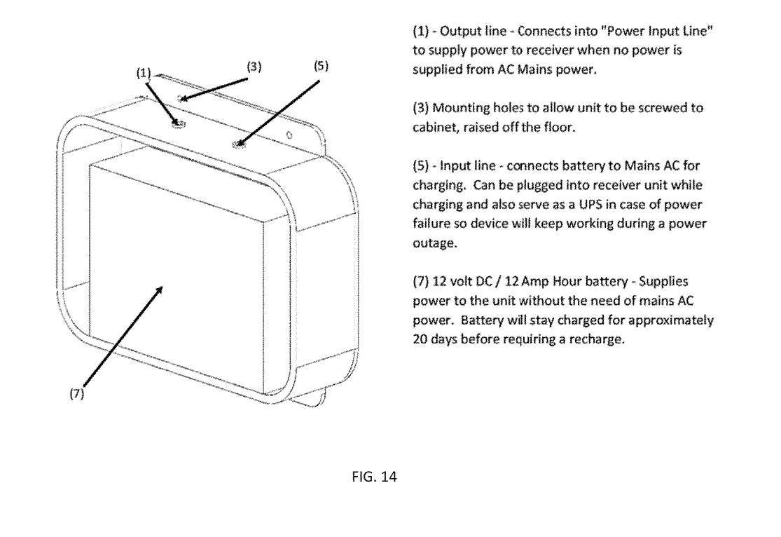

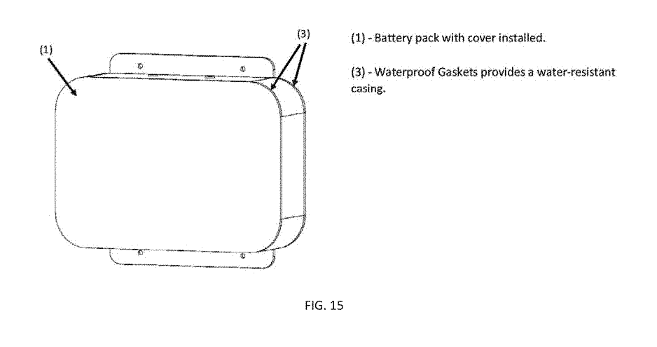

The hardware of an embodiment of the present disclosure is described herein in further detail with reference to FIGS. 8-15. It should be appreciated that many alternative hardware configurations according to the principles of the present disclosure are also possible.

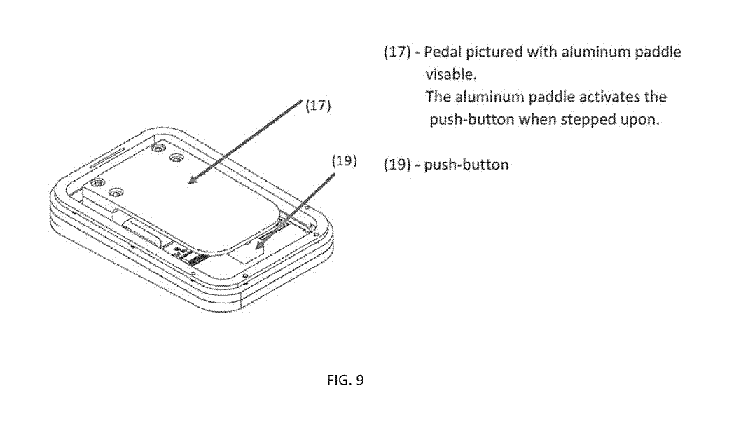

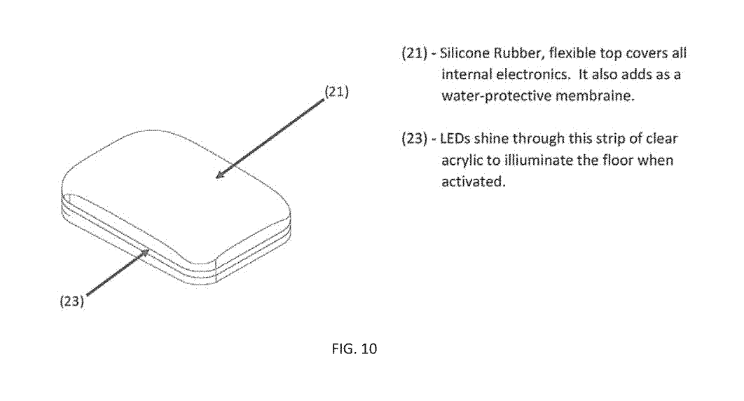

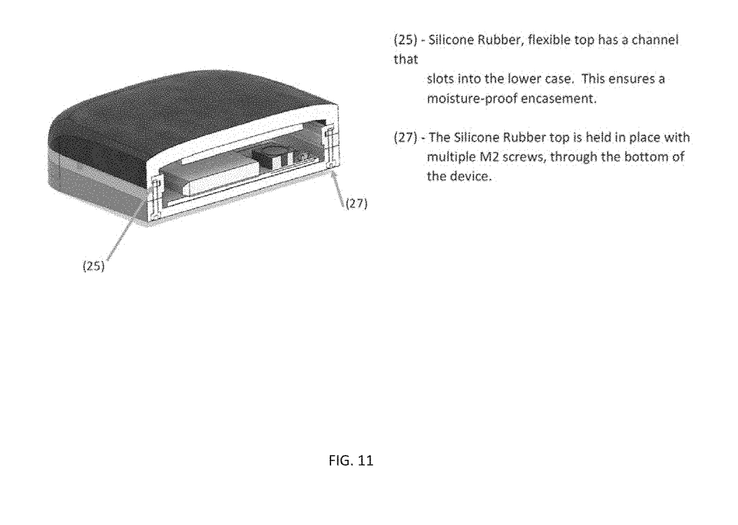

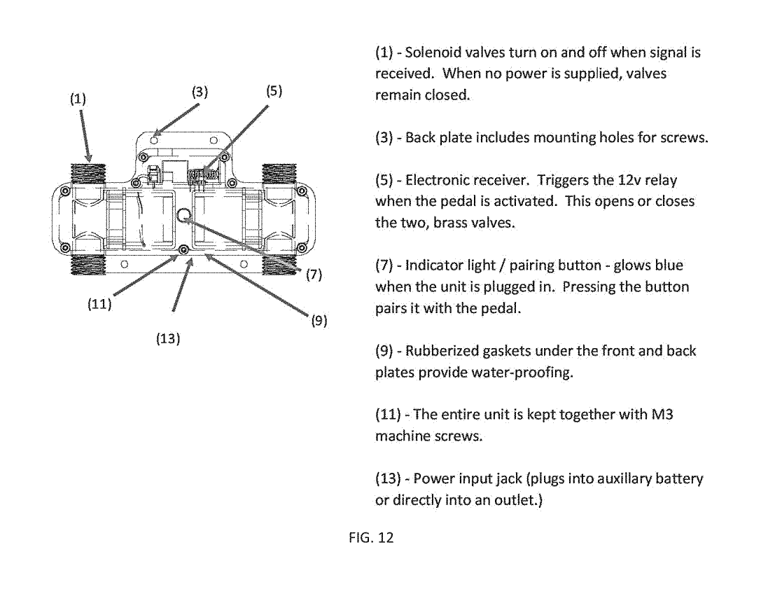

In the depicted embodiment of FIG. 8, the pedal includes a micro USB charging port 1, paddle mounting blocks 3, voltage converter 5, push button for activation of the water valve 7, rubberized bottom for grip 9, radio frequency transmitter 11 to send wireless signals to the valve system, a rechargeable battery 13, and an internal LED light and periphery windows 15 that allows the light to shine out from the pedal. In the depicted embodiment of FIG. 9, a pedal 17 is attached to the paddle mounting blocks 3 such that when the pedal 17 is depressed, it applies pressure onto the push button 19 to activate the water flow. In the depicted embodiment of FIG. 10, the pedal system includes a flexible cover 21 that seals the internal component from water and also allows for the depression of the pedal 17. In the depicted embodiment, the cover 21 is made of a silicon material. In the depicted embodiment of FIG. 11, the cover 21 has a lower edge that fits into a channel 25 in the base of the pedal 17 and screws 27 are inserted though the base of the pedal 17 to further secure the cover 21 to the base of the pedal 17. In the depicted embodiment of FIG. 12, the valve system includes a solenoid valve 1 that turns on and off the water based on the signal received from the pedal 17. When no power is supplied to the solenoid valve 1 (when the solenoid valve 1 is not activated), the water valve is in the off position. In the depicted embodiment, the valve system includes a receiver 5 that communicates with the transmitter 11 of the pedal 17. The valve system also includes a status indicator light 7 that illuminates when the pedal 17 and the valve system are paired.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A touchless faucet system including:
a wireless foot pedal configured to control the flow of water through a faucet; and
a valve system, the valve system including a solenoid valve that turns on and off the water based on the signal received from the pedal, wherein the solenoid valve is configured such that when no power is supplied to the solenoid valve, the water valve is in the off position.

2. The system of claim 1, wherein the valve system includes a receiver and the pedal includes a transmitter, and wherein the receiver of the valve system is configured to communicate with the transmitter of the pedal.

3. The system of claim 1, wherein the valve system further comprises a status indicator light that illuminates when the pedal and the valve system are paired.

4. The system of claim 1, wherein the pedal includes a rechargeable battery and a micro USB charging port.

5. The system of claim 1, wherein the pedal includes an internal LED light and a periphery window that allows the light to shine out from the pedal.

6. The system of claim 1, wherein the pedal includes a flexible cover that seals the internal component from water and also allows for the depression of the pedal.

7. The system of claim 1, wherein the cover has a lower edge that fits into a channel in the base of the pedal.

8. A method of converting a faucet into a touchless faucet comprising the steps of:
turning off the water supply;
disconnecting the faucet hoses from the existing manual water supply valves;
connecting the faucet hoses to the hot and cold outputs on a pedal controlled valve system;
connecting hoses between the input of the pedal controlled valve system to the manual water supply valves;
providing power to the pedal controlled valve system; and
pairing a pedal with the pedal controlled valve system.
